(19) United States
(12) Patent Application Publication
(10) Pub. No.: US 2016/0176738 A1
(43) Pub. Date: Jun. 23, 2016

(54) RECYCLING APPARATUS OF RINSING WASTEWATER FOR ELECTROPAINTING

(71) Applicant: Hyundai Motor Company, Seoul (KR)

(72) Inventor: Kwang-Mo Seong, Bucheon (KR)

(21) Appl. No.: 14/875,846

(22) Filed: Oct. 6, 2015

(30) Foreign Application Priority Data
Dec. 17, 2014 (KR) 10-2014-181948

(51) Int. Cl. C02F 9/00

(52) U.S. Cl. CPC C02F 9/00; C02F 1/283

(57) ABSTRACT

An apparatus for recycling rinsing wastewater for electropainting is provided. The apparatus includes a pre-filtration unit, a primary treated-water tank, a micro filtration unit, a secondary treated-water tank, an ultrafiltration unit, an active carbon filtration unit, a final treated-water tank, and an ultrasonic sterilizing unit. Accordingly, sludge is reduced through physical treatment without using a coagulant. Advantageously, the apparatus is installed at facilities having a reduced scale and provides additional facility options available due to elimination of a chlorine disinfectant. Furthermore the apparatus reduces costs for purchasing a coagulant, purchasing a disinfectant, and treating sludge, suppresses corrosion of a filtering device, and increases filtration time by delaying fouling of a filtering device.

### CROSS-REFERENCE TO RELATED APPLICATIONS

This application claims priority under 35 U.S.C. §119 to Korean Patent Application No. 10-2014-181948, filed on Dec. 17, 2014, in the Korean Intellectual Property Office, the disclosure of which is incorporated herein by reference in its entirety.

### BACKGROUND

1. Field of the Invention

The present invention provides an apparatus for recycling rinsing wastewater for electropainting, and more particularly, for electropainting which reduces sludge through physical treatment without using a coagulant.

2. Description of the Related Art

Generally, a high-quality water source is difficult to secure due to contamination of rivers and eutrophication by reservoirs and dams and the cost for purifying water is increasing due to an increase in personnel expenses and raw material prices, therefore the cost of water has substantially increased. As a dry season and a rainy season are clearly distinguished due to unusual temperature and a deficit of water is expected in the dry season, it is necessary to secure new water sources. However, securing a new water source is challenging due to economic, social, and environmental constraints. Under these circumstances, purifying and recycling of wastewater produced manufacturing processes may be a plan capable of reducing the costs for purchasing water and treating wastewater and may function as a new water source.

Electroplating used in the process of manufacturing vehicles specifically including a rinsing step in the painting pre-treatment process is water intensive. The electropainting process improves the anti-corrosive property and corrosion resistance of a vehicle body. During the process a paint coating is forcibly applied to a body of a vehicle using an electrical phenomenon by charging the vehicle body with a negative polarity and the paint with a positive polarity. The non-adhering paint on a vehicle body painted by electropainting is removed through ultrafiltration rinsing, including a three-stage rinsing process and final rinsing process utilizing pure water, thereby ensuring painting quality. The rinsing wastewater produced during the ultrafiltration rinsing is filtered and returned to an electropainting bath where the electropaint is filtered and separated through an ultrafiltration filter and then condensed. Finally, the filtered treated-water is reused as the rinsing water.

Next, the rinsing water produced by the three-stage rinsing and final rinsing is discharged and transported for treatment at a sewage water treatment plant. Typically, the rinsing waste water contains pure water and electropaint, thereby making the rinsing water suitable for recycling through an appropriate purifying process. For example, a technique for recycling electropainting wastewater includes recycling electropainting wastewater producing high-quality recycled water however, the process is complicated and difficult to manage. Additionally, there is a need for a substantial facility due to a large wastewater collection tank and a sludge deposition tank, and significant operational expenses including purchasing chemicals, treating sludge, and the cost of electricity for operating a blower for aeration.

An alternate method for treating rinsing wastewater includes a water tank-condensing tank, a film separation apparatus, an acid injection apparatus, and a pH measuring apparatus are included. The rinsing wastewater collected in the water tank-condensing tank is treated by the film separation apparatus, and the filtered treated-water is supplied to other processes. The condensed water then flows to the water tank-condensing tank. Further, acid is automatically injected by the pH measuring apparatus and the acid injection apparatus, therefore the pH of the treated-water is maintained within a predetermined range.

Beneficially, the above mentioned technique provides simplified maintenance and requires a relatively small facility, but condensed water is continuously returned back to the water tank-condensing tank from the film separation apparatus, therefore a substantially sized tank is required. Further, the concentration of the electropaint in the rinsing wastewater to be treated increases and there is not pre-treatment apparatus before the rinsing wastewater flows into the film separation apparatus. Consequently, fouling is generated on the separation film and the duration of the filtration limited.

Another method for treating rinsing wastewater includes a purifying apparatus for securing drinkable water using a self-power source that utilizes a power generator when the power supply is limited for instance, in circumstances related to natural disasters. The purifying apparatus is divided into a power supply portion and a purifying portion, in which the purifying portion includes a water supply pump, a pre-filter, a switch valve, a micro membrane filter, a reverse osmosis filter, an active carbon filter, a chlorine tank, and a chlorine agent injection pump.

Raw water supplied by the water supply pump is pre-treated by the pre-filter, and then transported to the micro membrane filter or the reverse osmosis filter by the switch valve, and then filtered. The treated-water filtered by the micro membrane filter is treated by the active carbon filter to remove impurities including odor impurities. The treated-water that has been subjected to the micro membrane filter and the active carbon filter or the reverse osmosis filter is disinfected with chlorine which then produces drinkable water. However, the technique has been designed to produce drinkable water for emergencies. For example, the process treats raw water having limited amounts of contamination. However, the process is not effective in treating electropainting wastewater contaminated that may contain substantial quantities of recycle treated-water from painting.

In particular, the processes utilizes the pre-filter, micro membrane filter, active carbon filter, and disinfecting with chlorine. Typically, removal of the contaminants contained in electropainting wastewater with the micro membrane filter involves a substantial level of difficulty. Consequently, a substantial amount of contaminants are removed by the active carbon filter, resulting in frequent replacement of the active carbon filter. For example, active carbon filters are typically installed in two lines and the two lines are alternately operated. Alternate operation of a plurality of filters results in an increased expense attributed to purchasing new active carbon and treat wasted active carbon. Further, when treated-water is discharged containing contaminants resulting from inappropriate maintenance of the active carbon filter, excessive quantities of chlorine are used in the chlorine disinfection process, THMs Tri-halomethanes (THMs), a carcinogenic substance is produced as a byproduct in the disinfection, and the remaining chlorine may cause corrosion of facilities and products.

In the processes by the pre-filter, reverse osmosis filter, and disinfecting with chlorine, the reverse osmosis filter operating at a high pressure requires frequent backwash since fouling may be generated by electropaint. However, backwashing may be difficult due to the adhesion of the electropainting and the high-pressure operation, such that the productivity of treated-water may be reduced. Therefore, the inventor(s) has attempted to develop an apparatus for recycling rinsing wastewater for electropainting which can solve the problems requiring a substantial facility, economical efficiency, maintenance, wastewater treatment, and quality.

The above information disclosed in this Background section is merely for enhancement of understanding of the background of the invention and therefore it may contain information that does not form the prior art that is already known in this country to a person of ordinary skill in the art.

### SUMMARY

The exemplary embodiment provides an apparatus for recycling rinsing wastewater produced during electropainting which may reduce sludge through physical treatment without requiring a coagulant by including a pre-filtration unit, a micro filtration unit, an ultrafiltration unit, an active carbon filtration unit, and an ultrasonic sterilizing unit.

An exemplary embodiment provides an apparatus for recycling rinsing wastewater for electropainting which may include a pre-filtration unit that may include having a pre-filter configured to filter and remove floats and electropaint flux in rinsing wastewater transported through an inlet; a primary treated-water tank that may be connected with the pre-filter unit and may maintain primary treated-water filtered by the pre-filter unit. A micro filtration unit may be connected with the primary treatment tank and may include a micro filtration separator configured to filter and remove electropaint particles in the primary treated-water. A secondary treated-water tank may be connected with the micro filtration unit and may maintain secondary treated-water filtered by the micro filtration unit. Further, an ultrafiltration unit may be connected with the secondary treated-water tank and may include an ultrafiltration separator configured to filter and remove the remaining contaminants in the secondary treated-water and an active carbon filtration unit may be connected with the ultrafiltration unit and may have an active carbon for adsorbing and removing ions, a odor, and a minimal amount of remaining contaminants in the secondary treated-water filtered by the ultrafiltration unit. A final treatment tank may be connected to the active carbon filtration unit and may filter final treated-water via the active carbon filtration unit and an ultrasonic sterilizing unit may be attached to the final treatment tank to remove microorganisms disposed in the final treated-water.

In another aspect, a portion of the secondary treated-water disposed in the secondary treated-water tank may be used as backwashing water for backwashing the micro filtration unit. For example, the backwashing water may be transported to the backwashing water inlet of the micro filtration unit and discharged through the backwashing water outlet by the backwashing water supply pump. The backwashing water may remove electropaint on the micro filtration separator of the micro filtration unit.

In some exemplary embodiments, the final treated-water in the final treated-water tank may be used as backwashing water for backwashing the ultrafiltration unit. The backwashing water may be transported to the backwashing water inlet of the ultrafiltration unit and discharged through the backwashing outlet by the backwashing water supply pump. Additionally, the backwashing water may remove remaining contaminants on the ultrafiltration separator of the ultrafiltration unit. In another embodiment, the final treated-water in the final treated-water tank may be used as backwashing water for backwashing the active carbon filtration unit. The backwashing water may be transported to the backwashing water inlet of the active carbon filtration unit and discharged through the backwashing outlet by the backwashing water supply pump. Additionally, the backwashing water may remove ions, an odor, and a minimal amount of contaminants adsorbed on the active carbons in the active carbon filtration unit.

The ultrasonic sterilizing unit may include an ultrasonic wave generator may be configured to generate ultrasonic waves; and an ultrasonic oscillator that may be vibrated by the ultrasonic waves generated by the ultrasonic generator. In other exemplary embodiments, the backwashing water that may be discharged through the backwashing water outlet of the micro filtration unit may be kept in a condensed water tank. The backwashing water discharged through the backwashing water outlet of the ultrafiltration unit may be maintained in the secondary treated-water tank. The backwashing water discharged through the backwashing water outlet of the active carbon filtration unit may be maintained in the secondary treated-water tank.

The apparatus according exemplary embodiments may reduce sludge through physical treatment without utilizing a coagulant. Additionally, the apparatus may be installed at facilities having a limited scale, and may reduce expenses associated with purchasing a coagulant, purchasing a disinfectant, and treating sludge. The apparatus may be maintained by automatic operation, may be readily available for various facilities due to elimination of the use of a chlorine disinfectant, may suppress corrosion of a filtering device, and may increase filtration time by delaying fouling of a filtering device.

### BRIEF DESCRIPTION OF THE DRAWINGS

FIG. 1 is an exemplary embodiment of a diagram illustrating the configuration of an apparatus for recycling rinsing wastewater for electropainting according to an exemplary embodiment of the present invention; and

FIG. 2 is an exemplary embodiment of an enlarge view schematically illustrating an ultrasonic sterilizer according to an exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the terms to describe most appropriately the best method he or she knows for carrying out the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, In order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

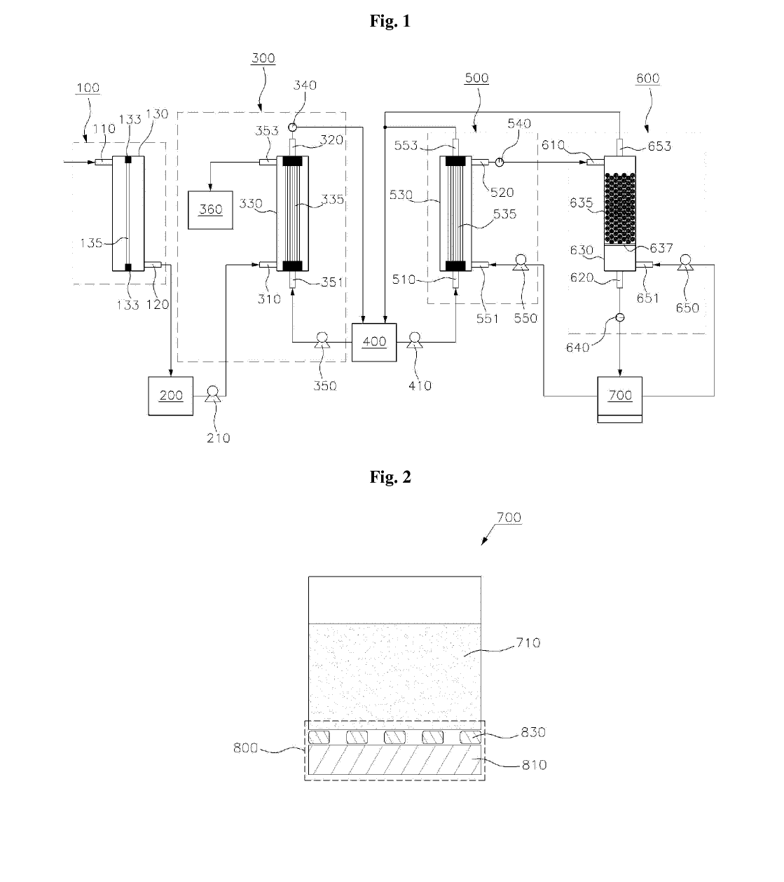

Hereinafter, an exemplary embodiment will be described in detail. The present invention provides an apparatus for recycling rinsing wastewater for electropainting which may recycle rinsing wastewater produced in electropainting, through physical treatment without utilizing a coagulant. An apparatus for recycling rinsing wastewater for electropainting according to an exemplary embodiment of the present invention may include as illustrated in FIG. 1, a pre-filtration unit 100 having a pre-filter 135 configured to filter and remove floats and electropaint flux in rinsing wastewater transported through an inlet 110; a primary treated-water tank 200 may be connected with the pre-filter unit 100 and may store primary treated-water filtered by the pre-filter unit 100.

Further a micro filtration unit 300 may be connected with the primary treatment tank 200 and may include a micro filtration separator 335 for that may filter and remove electropaint particles disposed in the primary treated-water. A secondary treated-water tank 400 may be connected with the micro filtration unit 300 and may store secondary treated-water filtered by the micro filtration unit 300. An ultrafiltration unit 500 may be connected with the secondary treated-water tank 400 and may include an ultrafiltration separator 535 that may filter and remove the remaining contaminants in the secondary treated-water. An active carbon filtration unit 600 may be connected with the ultrafiltration unit 500 and may have an active carbon 635 that may adsorb and remove ions, an odor, and a minimal amount of remaining contaminants in the secondary treated-water filtered by the ultrafiltration unit 500. A final treatment tank 700 may connect the active carbon filtration unit 600 and may store the final treated-water 710 filtered by the active carbon filtration unit 600 and an ultrasonic sterilizing unit 800 may be attached to the final treatment tank 700 to remove microorganisms disposed in the final treated-water 710.

In particular, the pre-filtration unit 100 may include the pre-filter 135 and a pre-filter case 130 that may fix the pre-filter 135 and may provide a treatment space for wastewater, and the pre-filter case 130 may have the inlet 110 through which electropainting wastewater may flow to the interior, a fixing rail 133 that may fix the pre-filter, and an outlet 120 through which the primary treated-water may be discharged. The micro filtration unit 300 may include the micro filtration separator 335, a micro filtration unit case 330 that may fix the micro filtration separator 335 and may provide a treatment space for wastewater, a manometer 340, and a backwashing water supply pump 350. The micro filtration unit case 330 may have an inlet 310 through which the primary treated-water may flow within, an outlet 320 through which the secondary treated-water may be discharged, a backwashing water inlet 351, and backwashing water outlet 353.

The ultrafiltration unit 500 may include the ultrafiltration separator 535, an ultrafiltration unit case 530 that may fix the ultrafiltration separator 535 and may provide a treatment space for wastewater, a manometer 540, and a backwashing water supply pump 550. The ultrafiltration unit case 530 may have an inlet 510 through which the secondary treated-water may flow within, a third treated-water outlet 520, a backwashing water inlet 551, and backwashing water outlet 553. The active carbon filtration unit 600 may include an active carbon filtration unit case 630 forming an active carbon filtration layer and may provide a treatment space for wastewater, active carbons 635, a flowmeter 640, and a backwashing water supply pump 650. The active carbon filtration unit case 630 may have an inlet 610 through which third treated-water may flow within, an outlet 620 through which final treated-water may be discharged, an active carbon support 637, a backwashing water inlet 651, and a backwashing water outlet 653.

Moreover, some of the secondary treated-water disposed the secondary treated-water tank 400 may be used as backwashing water for backwashing the micro filtration unit 300. The backwashing water may be transported to the backwashing water inlet 351 of the micro filtration unit 300 and may be discharged through the backwashing water outlet 353 by the backwashing water supply pump 350 connected with the secondary treated-water tank 400. The backwashing water may flow in the opposite direction for filtration and may flow to the exterior from the interior of the micro filtration separator 335 thereby removing the electropaint particles condensed on the micro filtration separator 335. In other words, since the micro filtration unit 300 may be configured to filter electropainting particles from the treated-water flowing to the interior from the exterior of the micro filtration separator 335, as the filtration time elapses, the electropainting particles may be condensed on the exterior side of the micro filtration separator 335, thereby reducing the transmission efficiency. For example, backwashing to remove the electropainting particles condensed on the micro filtration separator 335 may improve the method.

In particular, the backwashing water including the electropainting particles removed by backwashing may be transported to the condensing tank 360 through the backwashing outlet 353 of the micro filtration unit 300. When required, the backwashing water may be returned to the micro filtration unit 300 and reused or may be transported to a sewage water treatment plant for further treatment. The backwashing for the micro filtration separator 335 may be performed with aeration and may be performed after completion of the filtration by the micro filtration unit 300 and filtration by the micro filtration unit 300 may be performed after the backwashing is completed.

Similarly, a portion of the final treated-water 710 disposed in the final treated-water tank 700 may be used as backwashing water for backwashing the ultrafiltration unit 600 and the backwashing water may be transported to the backwashing water inlet 551 of the ultrafiltration unit 500 and may be discharged through the backwashing outlet 553 by the backwashing water supply pump 550. The backwashing water may flow in the opposite direction to that of the filtration which flows from the exterior to the interior of the ultrafiltration separator 535. Additionally, the remaining contaminants condensed and accumulated on the ultrafiltration separator 535 may be removed.

Furthermore, the ultrafiltration separator 535 of the ultrafiltration unit 500 may be configured to filter remaining contaminants such as low-molecular resin, non-reacting substances, and organic substances from the treated-water flowing to the interior from the exterior of the ultrafiltration separator 530. As the filtration time elapses, the remaining contaminants may form a contaminant cake layer by being condensed and accumulated on the exterior side of the micro filtration separator 535. For example, the transmission efficiency of the ultrafiltration separator 535 may be reduced. Backwashing for removing the cake layer of contaminants condensed and accumulated on the ultrafiltration separator 535 may be required. The backwashing water including contaminants removed by the backwashing may be transported to the secondary treated-water tank 400 through the backwashing water outlet 553 of the ultrafiltration unit 500 and reused. Additionally, the backwashing water may be transported to a sewage water treatment plant and further treated. The backwashing for the ultrafiltration separator 535 may be performed with aeration and may be performed after filtration by the ultrafiltration unit 500 is completed, and filtration by the ultrafiltration unit 500 may be performed after the backwashing is completed.

Further, a portion of the final treated-water 710 disposed in the final treated-water tank 700 may be used as backwashing water for backwashing the active carbon filtration unit 600. The backwashing water may be transported to the backwashing water inlet 651 of the active carbon filtration unit 600 and may be discharged through the backwashing outlet 653 by the backwashing water supply pump 650. The backwashing water flowing upward opposite to that for filtration may remove ions, an odor, and a minimal amount of remaining contaminants adsorbed on the active carbons 635. The active carbons 635 in the active carbon filtration unit 600 may adsorb ions, an odor, and a minimal amount of remaining contaminants from the treated-water, the adsorption efficiency of the surfaces of the active carbons 635 decreases as the filtration time elapses. Additionally, backwashing for removing the ions, odor, and remaining contaminants on the active carbons 635 may be required.

The backwashing water including the ions, the odor, and the minimal amount of remaining contaminants removed by the backwashing may be transported to the secondary treated-water tank 400 through the backwashing water outlet 653 of the active carbon filtration unit 600 and reused. Additionally, when necessary, the backwashing water may be transported to a sewage water treatment plant and further treated. The backwashing for the active carbon filtration unit 600 may be performed with aeration and may performed after filtration by active carbon filtration unit 600 is completed, and filtration by the active carbon filtration unit 600 may be performed after the backwashing is completed. Furthermore, when the quality of the final treated-water is not improved even after the active carbon filtration unit is backwashed, the active carbons 635 may be replaced.

Alternatively, as illustrated in FIG. 2, the ultrasonic sterilizing unit 800 may include an ultrasonic wave generator 810 that may be configured to generate ultrasonic waves; and an ultrasonic oscillator 830 that may be configured to generate a vibration using the ultrasonic waves generated by the ultrasonic generator 810. The ultrasonic oscillator 830 of the ultrasonic sterilizing unit 800 may be installed exterior to the final treated-water tank 700, enabling prevention of deterioration of the sterilizing efficiency due to contamination on the ultrasonic oscillator 830. Further, the ultrasonic oscillator 830 may be three-dimensionally installed on various sides, in addition to a side of the final treated-water tank, thereby eliminating a dead zone and maximizing the sterilizing effect of the final treated-water 710.

The backwashing water discharged through the backwashing water outlet 353 of the micro filtration unit 300 may be maintained in the condensed water tank 360, the backwashing water discharged through the backwashing water outlet 553 of the ultrafiltration unit 500 may be maintained in the secondary treated-water tank 400. The backwashing water discharged through the backwashing water outlet of the active carbon filtration unit 600 may be maintained in the secondary treated-water tank 400. Further, the primary treated-water disposed in the primary treated-water tank 200 may be supplied to the micro filtration unit by the primary treated-water supply pump 210 and the secondary treated-water in the secondary treated-water tank 400 may be supplied to the ultrafiltration unit by the secondary treated-water supply pump 410.

The apparatus for recycling rinsing wastewater for electropainting according to an exemplary embodiment of the present invention may be used for recycling wastewater produced in a rinsing process of removing foreign substances on an object painted in electropainting.

### Example

The exemplary embodiment described herein provides an apparatus for recycling rinsing wastewater for electropainting and a comparative example of a chemical treatment apparatus.

TABLE 1

| | Exemplary Embodiment | | | Comparative example | | |
|---|---|---|---|---|---|---|
| | Raw | Treated- | Treatment | Raw | Treated- | Treatment |
| Item | wastewater | water | efficiency | wastewater | water | efficiency |
| Organic | 1,276 mg/l | 7.7 mg/l | 99.4% | 978 mg/l | 6.8 mg/l | 99.3% |
| substances | | | | | | |
| Floats | 58.7 mg/l | 0 mg/l | 100% | 87.3 mg/l | 0 mg/l | 100% |
| Common | 10,000 | 0 | 100% | 10,000 | 0 | 100% |
| bacteria | cfu/100 ml | cfu/100 ml | | cfu/100 ml | cfu/100 ml | |

Table 1 compares the efficiencies of treating rising wastewater for electropainting by an exemplary embodiment of the apparatus for recycling rinsing wastewater for electropainting according to an exemplary embodiment and a comparative example of a chemical treatment apparatus.

In the exemplary embodiment, a hollow fiber type (ID 0.65 mm, OD 1.0 mm) was used for a micro filtration separator of a micro filtration unit, the size of apertures of the separator was 0.2 μm or less, flux was 45 l/m²-Hr or less, and operation pressure was 1.0 kgf/cm² or less. In the embodiment, a hollow fiber type (ID 1.2 mm, OD 1.8 mm) was used for an ultrafiltration separator of an ultrafiltration unit, the size of apertures of the separator was 0.0.1 μm or less, flux was 65 to 75 l/m²-Hr, and operation pressure was 2.0 kgf/cm² or less.

Alternatively, the chemical treatment apparatus in the comparative example includes a cohering unit, a float separating unit, a sand filtration unit, an active carbon filtration unit, an ozone oxidizing unit, a micro filtration unit, and an ultrafiltration unit. The chemical treatment apparatus of the comparative example required injecting a coagulant of about 375 ml/m³, a pH conditioner of about 275 ml/m³, and a cohering agent of about 75 ml/m³. As the result of the test on the embodiment and the comparative example, the embodiment treated organic substances by 99.4% and floats and common bacteria by 100%. The comparative example also treated organic substances by 99.3% and floats and common bacteria by 100%.

However, it could be found from the test that the exemplary embodiment physically treated the substances without using a chemical such as a coagulant, thereby reducing environmental contamination due to use of a chemical and it did not produce sludge unlike that the comparative example which produced a sludge of about 125 l/m³. Therefore, the apparatus for recycling rinsing wastewater for electropainting according to the exemplary embodiment did not produce sludge without using a chemical while being equal in treatment efficiency to the chemical treatment apparatus of the related art.

The invention was described in connection with what is presently considered to be exemplary embodiments, but on the contrary, is intended to cover various modifications and equivalents arrangements included within the sprit and scope of the appended claims. In addition it is to be considered that all of these modifications and alterations fall within the scope of the present invention and the claims to be described below.

What is claimed is:

1. An apparatus for recycling rinsing wastewater for electropainting, comprising:
a pre-filtration unit that includes a pre-filter configured to filter and remove floats and electropaint flux in rinsing wastewater transported through an inlet;
a primary treated-water tank connected with the pre-filter unit and configured to store primary treated-water filtered by the pre-filter unit;
a micro filtration unit connected with the primary treatment tank and includes a micro filtration separator configured to filter and remove electropaint particles in the primary treated-water;
a secondary treated-water tank connected with the micro filtration unit and configured to store secondary treated-water filtered by the micro filtration unit;
an ultrafiltration unit connected with the secondary treated-water tank and includes an ultrafiltration separator configured to filter and remove remaining contaminants in the secondary treated-water;
an active carbon filtration unit connected with the ultrafiltration unit and has an active carbon for adsorbing and removing ions, an odor, and a minimal amount of remaining contaminants in the secondary treated-water filtered by the ultrafiltration unit;
a final treatment tank connected the active carbon filtration unit and configured to store final treated-water filtered by the active carbon filtration unit; and
an ultrasonic sterilizing unit attached to the final treatment tank to remove microorganisms disposed in the final treated-water.

2. The apparatus of claim 1, wherein a portion of the secondary treated-water in the secondary treated-water tank is used as backwashing water for backwashing the micro filtration unit and the backwashing water is transported to the backwashing water inlet of the micro filtration unit and discharged through the backwashing water outlet by the backwashing water supply pump, so that the backwashing water removes electropaint disposed on the micro filtration separator of the micro filtration unit.

3. The apparatus of claim 1, wherein a portion of the final treated-water in the final treated-water tank is used as backwashing water for backwashing the ultrafiltration unit and the backwashing water is transported to the backwashing water inlet of the ultrafiltration unit and discharged through the backwashing outlet by the backwashing water supply pump, to remove remaining contaminants on the ultrafiltration separator of the ultrafiltration unit.

4. The apparatus of claim 1, wherein a portion of the final treated-water in the final treated-water tank is used as backwashing water for backwashing the active carbon filtration unit and the backwashing water is transported to the backwashing water inlet of the active carbon filtration unit and discharged through the backwashing outlet by the backwashing water supply pump, so that the backwashing water removes ions, an odor, and a minimal amount of contaminants adsorbed on the active carbons in the active carbon filtration unit.

5. The apparatus of claim 1, wherein the ultrasonic sterilizing unit includes:
an ultrasonic wave generator configured to generate ultrasonic waves; and
an ultrasonic oscillator vibrated by the ultrasonic waves generated by the ultrasonic generator.

6. The apparatus of claim 2, wherein the backwashing water discharged through the backwashing water outlet of the micro filtration unit is stored in a condensed water tank.

7. The apparatus of claim 3, wherein the backwashing water discharged through the backwashing water outlet of the ultrafiltration unit is stored in the secondary treated-water tank.

8. The apparatus of claim 4, wherein the backwashing water discharged through the backwashing water outlet of the active carbon filtration unit is stored in the secondary treated-water tank.

9. The apparatus of claim 1, wherein the apparatus for electropanting is used to apply the electropaint particle a vehicle.
